(19) United States
(12) Patent Application Publication
(10) Pub. No.: US 2025/0036496 A1
(43) Pub. Date: Jan. 30, 2025

(54) METHOD AND DEVICE FOR AUTOMATICALLY GENERATING A REST API SPECIFICATION BASED ON A PLAIN-TEXT USER STORY

(71) Applicant: Siemens Aktiengesellschaft, Munchen (DE)

(72) Inventors: Daniel Bäuml, Nürnberg (DE); Rohit Gupta, München (DE)

(21) Appl. No.: 18/225,977

(22) Filed: Jul. 25, 2023

(51) Int. Cl. G06F 9/54

(52) U.S. Cl. CPC G06F 9/547; G06F 40/279

(57) ABSTRACT

A computer-implemented method for automatically generating a REST API specification based on a plain-text user story comprising: receiving the plain-text user story comprising a number of plain-text sentences that constitute a requirements definition for an API-driven control application to be developed; identifying a number of nouns and a number of verbs in the acquired plain-text user story; matching the identified number of verbs to one of a plurality of HTTP methods; matching the number of identified nouns to a number of HTTP resources; building a REST path using the matched HTTP method and the number of matched HTTP resources; and generating and outputting a REST API specification comprising at least the built REST path. Stability of a system to which the control application is deployed is increased. Also proposed is a corresponding computing device.

### FIELD OF TECHNOLOGY

The present invention relates to the field of industrial control systems having software execution environments in which a plurality of control applications can be deployed for controlling, through collective operation of the plurality of control applications, one or more industrial devices controlled by the industrial control system, and, more particularly, to the field of developing such control applications.

### BACKGROUND

Control applications for industrial control systems typically are API-driven control applications that do not necessarily have a user interface, but provide one or more API endpoints through which the API-driven control applications consume and provide data, such as control data and status data.

One example of an API endpoint is as a Representational State Transfer, REST, API that can be called by an API user by sending an HTTP request to a specific REST path using one of a plurality of predefined HTTP methods. OpenAPI is a widely used format for API specifications for REST APIs.

Nowadays, industrial control systems tend to be complex, comprising a large number of individual API-driven control applications. The development of an API-driven control application takes place in a traditional waterfall-type environment or in a modern agile development environment, such as SCRUM.

In either case, a user who requires a specific control application to be developed writes down requirements in plain text. A software developer then reads and analyzes the requirements, manually designs an API specification, and proceeds to develop code implementing the corresponding functionality. Alternatively, the software developer, after reading and analyzing the requirements, may proceed to developing code implementing the required functionality straight away, and afterwards create an API specification based on the developed code.

However, the process of translating human-written plain-text requirements into an API specification and/or into code requires human expertise and is prone to errors.

It has been discovered that software developments projects tend to fail early-on due to a mismatch between the human-designed API specification and the requirements of the user, such that the user ends up with a control application that does not provide the desired functionality or does at least not provide the desired functionality in the required manner.

Such a mismatch between the API specification and/or the implemented functionality with the user requirements may not only lead to a failure of the software development project. Such a mismatch may go undetected for a long time and may even result in the deployment of incorrectly functioning control applications on the industrial control system. Ultimately, there is a risk for hardware failure of the controlled device due to unexpected behavior of the mismatching deployed control application.

### SUMMARY

Thus, it is an object of the present invention to improve the development of API-driven control applications so as to improve the reliability of operation of an industrial control system.

According to a first aspect, the inventors propose a computer-implemented method for automatically generating a representational state transfer, REST, application programming interface, API, specification based on a plain-text user story, the method comprising: a) receiving, as input, the plain-text user story comprising a number of plain-text sentences that constitute a requirements definition for an API-driven control application to be developed: b) identifying a number of nouns and a number of verbs in the acquired plain-text user story: c) matching the identified number of verbs to one of a plurality of HTTP methods: d) matching the number of identified nouns to a number of HTTP resources: e) building a REST path using the matched HTTP method and the number of matched HTTP resources; and f) generating and outputting a REST API specification that comprises at least the built REST path.

Accordingly, the REST API specification can be generated automatically from the plain-text user story. Thus, human errors occurring in this step are eliminated, the probability of the generated REST API specification matching the requirements of the user is improved. Accordingly, failure of a complex software development project can be prevented, and furthermore, an operating reliability of the industrial control system on which the developed API-driven control application is to be deployed can be improved.

Here and in the following, the term “a number of” shall be construed as “a number of one or more”, i.e., “N≥1”, unless noted otherwise.

Here and in the following, claims, for terms such as “user”, “operator”, “developer” and the like, independent of the grammatical term usage, individuals with male, female or other gender identities are included within the term.

In particular, an API-driven control application is a control application that provides its functionality (or at least a relevant part thereof) via a callable API and, more particularly, via a REST API.

In particular, a control application is an application that provides functionality which directly or indirectly contributes to controlling an industrial device that is controlled by an industrial control system.

More particularly, said functionality may include the reading of measured values from sensors, the writing of setting values to actors, and/or the further processing of control data or status data comprising, in particular, measured values, setting values and/or data derived therefrom.

The plain-text user story may be in a SCRUM API User Story format. Thus, the plain-text user-story may comprise at least a persona section, a need section and a goal section. Herein, in particular, each section comprises at least a number of words constituting at least a phrase of a sentence. Herein, more particularly, the persona section, the need section and the goal section together may specify who (persona) wants what (need) and why (goal).

The plain-text user story may also be in a Gherkin Story format and may, in addition to the persona section, the need section and the goal section, further comprise a pre-condition section, an actions/input section and a results section.

The plurality of HTTP methods may comprise, in particular, the HTTP methods that are defined by the HTTP standard, such as, in particular, GET, HEAD, POST, PUT, DELETE, CONNECT, TRACE, PATCH.

Matching one verb to one of a plurality of HTTP methods may comprise selecting the one of the plurality of HTTP methods that most closely matches the semantic meaning of the respective verb, based on semantic analysis, natural language processing, pre-defined verb-method associations, or the like.

Matching a plurality of verbs to one of a plurality of HTTP methods may comprise, for example, selecting one verb of the plurality of verbs and matching the selected one verb to one of the plurality of HTTP methods.

Alternatively, matching a plurality of verbs to one of a plurality of HTTP methods may comprise, for example, tentatively matching each of the plurality of verbs to a respective one of the plurality of HTTP methods and selecting one HTTP method from the plurality of tentatively matched HTTP methods as the one matching HTTP method of the plurality of HTTP methods.

Matching the number of nouns to a number of HTTP resources may comprise selecting one or more or all of the nouns as respective HTTP resources to be used in step e).

In each case described above, in particular, the respective selecting may be performed based on semantic analysis, natural language processing, pre-defined associations between verbs and HTTP methods and/or nouns and HTTP resources, frequency of occurrence of the respective noun or verb, position of the respective noun or verb in the plain-text user story, or the like.

In particular, the REST API specification may be an OpenAPI specification.

The REST API specification may be output to a human developer who is tasked with developing code corresponding to the REST API specification. In this case, the REST API specification may be output by being displayed or may be output by being transmitted as, or stored as, a text file.

The REST API specification may also be output, as a text file or the like, to a computing device, which may be the same computing device that implements the proposed method, or to a different computing device, for use in automated validation of an API-driven control application, as will be described with preferred embodiments hereinbelow.

According to an embodiment, in step b), the number of nouns and the number of verbs are identified by comparing each word comprised by each of the number of plain-text sentences with a predetermined list of verbs and a predetermined list of nouns.

Thus, the plain-text user story may be written using controlled language using a well-defined vocabulary of nouns and verbs. In this way the risk of an error arising from an ambiguity in the plain-text user story is advantageously reduced, and the identification of verbs and nouns can be implemented in a simple manner.

According to a further embodiment, in step b), the number of nouns and the number of verbs are identified through natural language processing.

Accordingly, a user has a higher degree of freedom in formulating the plain-text user story.

According to a further embodiment, in step b), a plurality of verbs are identified, a most relevant verb of the plurality of verbs is identified based on its position within the plain-text user story, and the most relevant verb is matched to one of the plurality of HTTP methods in step c).

The most relevant verb may be a first verb in a need section of the plain-text user story. Alternatively, the most relevant verb may be a verb in the need section of the plain-text user story that has been identified, through natural language processing, to constitute the predicate of the phrase or sentence in the need section. Other criteria of selecting the most relevant verb are conceivable depending on the rules of the human language in which the plain-text user story is written.

Thus, the proposed method can deal with a user-story comprising more than one verb and can still correctly identify the best-matching HTTP method.

According to a further embodiment, in step c), the most relevant verb is matched to a library in which each HTTP method is associated with a number of verbs.

For example, a match may be found when the most relevant verb in the acquired plain-text user story exactly matches one of the verbs in the library. In this case, the plain-text user story may be written using controlled language using a well-defined vocabulary of verbs. In this way the risk of an error arising from an ambiguity in the plain-text user story is advantageously reduced, and the matching of verbs to HTTP methods nouns can be implemented in a simple and reliable manner.

Alternatively, fuzzy-matching between the most relevant verb and the verbs in the library may be performed.

Alternatively, natural language processing of the need section or of the entire user-story may be used to obtain a semantic meaning of the most relative verb, and the semantic meaning of the most relative verb may be matched to the semantic meanings of the verbs in the library, which may be stored in the library in association with a respective verb. Accordingly, a user has a higher degree of freedom in formulating the plain-text user story.

According to a further embodiment, if in step b), a plurality of nouns are identified, in step d), one of the plurality nouns is identified as a HTTP root resource to be used in the REST path, and a number of the plurality of nouns are identified as sub-resources, based on criteria including one or more of: a position of the respective noun in the plain-text user story: a frequency of occurrence of the respective noun in the plain-text user story: a positional or grammatical relationship of the respective noun with the one of the number of plurality of verbs that was matched to the HTTP method.

In particular, a HTTP root resource is a resource that comes first in the REST path, while sub-resources are resources that either come as HTTP sub-resources after the HTTP root resources in the REST path, or that are to be used in a request body of the HTTP request rather than in the REST path.

Thus, the proposed method can properly identify the HTTP root resource, thereby increasing the suitability of the generated API specifications for the requirements specified by the user in the user story.

According to a further embodiment, if the number of nouns identified as sub-resources is greater than a predetermined threshold, the number of nouns identified as sub-resources is further subdivided, based on the criteria, into a first number of nouns to be used as HTTP sub-resources in the REST path and a second number of nouns to be used as sub-resources in a request body description, and the REST API specification generated in step f) further comprises the request body description.

Thus, advantageously, an overly longish REST path can be avoided.

According to a further embodiment, if in step b), a plurality of nouns are identified as HTTP sub-resources to be used in the REST path, in step e), a plurality of REST paths is generated, each of the plurality of REST paths comprising the HTTP root resource and, in an order that differs for each of the plurality of REST paths, the HTTP sub-resources, and in step f), the plurality of REST paths is included in the REST API specification.

Thus, the proposed method can advantageously explore some or all possible combinations of suitable REST paths, and the developer can then select and use one of the plurality of REST paths.

Exploration of all possible combinations of suitable REST paths also has an advantageous effect when the API specification output by the proposed method is used not only by a human developer for implementing the code of the API-driven control application, but is used also for automated validation of an API-driven control application, as will be described hereinbelow.

According to a further embodiment, the proposed method further comprises steps for validating the API-driven control application prior to its deployment to an industrial control system, the furthe steps comprising: g) receiving, as input, source code of the API-driven control application, h) generating a REST API specification based on the received source code of the API-driven control application, i) validating the API-driven control application under the condition that the REST API specification generated in step h) based on the source code of the API-driven control application matches the REST API specification generated in step f) based on the plain-text user story.

A developer may choose to develop an API-driven control application based on his own human analysis of the plain-text user story. In this case, the proposed method steps g) to i) advantageously allow validating the human-developed API-driven control application against the plaintest user story by comparing a REST API specification generated from the source code of the API-driven control application with a REST API specification generated according to steps a) to f). If at least one of the REST paths in the one REST API specification matches with at least one of the REST PATHS of the other REST API specification, it can be concluded that the likelihood is high, that the API-driven control application behaves according to the user requirements set out in the plain-text user story. Successful validation may be made a precondition for deployment of the API-driven control application on the industrial system. As such, operational stability of the industrial control system may be advantageously improved.

It is noted that in the present embodiment, it is especially advantageous if the REST API specification generated in step f) comprises a plurality of REST paths which explore a plurality of or all possible combinations of the HTTP root resources with the HTTP sub-resources. In this way, the likelihood of detecting a match is advantageously increased.

Any known method may be used for generating the REST API specification based on the source code. For example, generating the REST API specification based on the source code may be performed by parsing the source code, based on annotations in the source code, or the like.

According to a further embodiment, the proposed method further comprises j) building the API-driven control application from the received source code only if the validation step i) is successful.

According to a further embodiment, the proposed method further comprises k) deploying the API-driven control application to the industrial control system only if the validation step i) is successful.

According to both of the last-described embodiments, the proposed method may thus be executed on a development support device that is part of a tool chain for deploying API-driven control applications to the industrial control chain, and may advantageously act as a safeguard for only letting API-driven control applications be built and/or deployed if they underwent validation according to step i).

Thus, the operational stability of the industrial control system can be improved, mismatches in the API specification can be detected far upstream before the API-driven control application reaches the industrial control device, and software projects can be prevented from failing.

Any embodiment of the first aspect may be combined with any embodiment of the first aspect to obtain another embodiment of the first aspect.

According to a second aspect there is proposed a computer program product comprising a program code for executing the above-described method when run on at least one computer.

A computer program product, such as a computer program means, may be embodied as a memory card, USB stick, CD-ROM, DVD or as a file which may be downloaded from a server in a network. For example, such a file may be provided by transferring the file comprising the computer program product from a wireless communication network.

According to a third aspect, there is proposed a computing device configured for automatically generating a representational state transfer, REST, application programming interface, API, specification based on a plain-text user story, the computing-device comprising: a) a first unit configured to receive, as input, the plain-text user story comprising a number of plain-text sentences that constitute a requirements definition for an API-driven control application to be developed; b) a second unit configured to identify a number of nouns and a number of verbs in the acquired plain-text user story: c) a third unit configured to match the identified number of verbs to one of a plurality of HTTP methods: d) a fourth unit configured to match the number of identified nouns to a number of HTTP resources: e) a fifth unit configured to build a REST path using the matched HTTP method and the number of matched HTTP resources; and f) a sixth unit configured to generate and output a REST API specification that comprises at least the built REST path.

The respective unit may be implemented in hardware and/or in software. If said unit is implemented in hardware, it may be embodied as a device, e.g., as a computer or as a processor or as a part of a system, e.g., a computer system. If said unit is implemented in software it may be embodied as a computer program product, as a function, as a routine, as a program code or as an executable object.

According to a fourth aspect, the computing device of the third aspect is further configured for validating the API-driven control application prior to its deployment to an industrial control system, and the computing device further comprises: g) a seventh unit configured to receive, as input, source code of the API-driven control application, h) an eight unit configured to generate a REST API specification based on the received source code of the API-driven control application, i) a ninth unit configured to validate the API-driven control application under the condition that the REST API specification generated by the eight unit based on the source code of the API-driven control application matches the REST API specification generated by the sixth unit based on the plain-text user story.

According to a fifth aspect, there is proposed an industrial control system comprising a software execution environment to which one or more API-driven control applications for controlling one or more industrial devices are deployable and comprising the above-described computing device of the third or fourth aspect.

The embodiments, features and advantages described with reference to the device of the method aspect apply mutatis mutandis to the computer program product of the second aspect, to the computing device of the third aspect, to the computing device of the fourth aspect, and to the industrial control system of the fifth aspect.

Further possible implementations or alternative solutions of the invention also encompass combinations—that are not explicitly mentioned herein—of features described above or below with regard to the embodiments. The person skilled in the art may also add individual or isolated aspects and features to the most basic form of the invention.

### BRIEF DESCRIPTION

Further embodiments, features and advantages of the present invention will become apparent from the subsequent description and dependent claims, taken in conjunction with the accompanying drawings, in which:

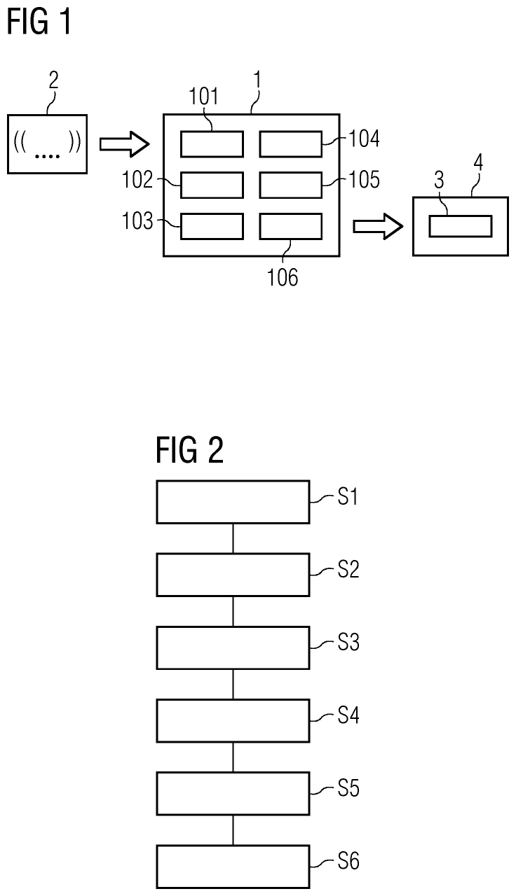

FIG. 1 is a diagram illustrating the functional configuration of a computing device according to a first exemplary embodiment;

FIG. 2 illustrates steps of a method according to the first exemplary embodiment:

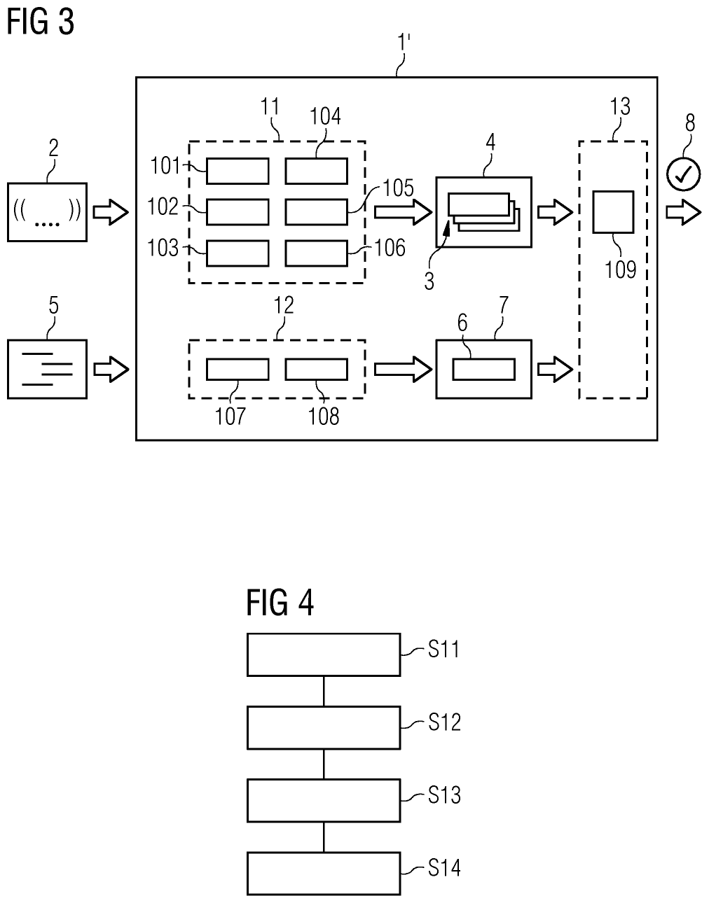

FIG. 3 is a diagram illustrating the functional configuration of a computing device according to a second exemplary embodiment:

FIG. 4 illustrates steps of a method according to the second exemplary embodiment:

FIG. 5 is a diagram illustrating the functional configuration of a computing device according to a third exemplary embodiment; and

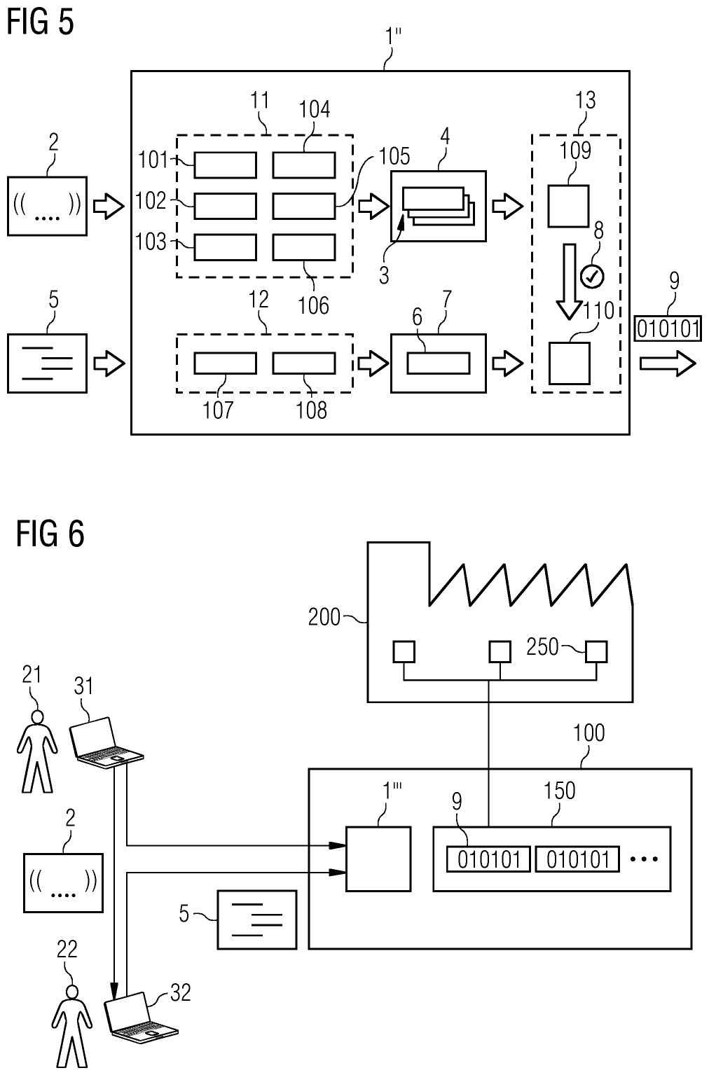

FIG. 6 is a diagram illustrating the functional configuration of an industrial control system according to a fourth exemplary embodiment.

### DETAILED DESCRIPTION

In the Figures, like reference numerals designate like or functionally equivalent elements, unless otherwise indicated.

FIG. 1 is a diagram illustrating the functional configuration of a computing device 1 according to a first exemplary embodiment, and FIG. 2 illustrates steps S1-S6 of a method according to the first exemplary embodiment.

The computing device 1 may be a standard PC, an industrial PC, an embedded controller, or the like and may have any suitable structure, such as, for example, a structure comprising a central processing unit, volatile memory, permanent storage, network adapter, and the like (not shown). When a program that is stored in the permanent storage or a program downloaded from a network via the network adapter is loaded into the volatile memory and is being executed by the central processing unit, the computing device 1 may form the functional configuration shown in FIG. 1.

That is, the computing device 1, when the program executes, comprises the following functional units: a first unit 101, a second unit 102, a third unit 103, a fourth unit 104, a fifth unit 105 and a sixth unit 106; and performs the following method:

In step S1, the first unit 101 receives a plain-text user story 2 as input. The plain-text user story comprises one or more plain-text sentences that define requirements for an API endpoint of an API-driven control application that is to be developed.

Merely as one example, the plain user story may be in a SCRUM API User Story format and may comprise a persona section starting with “As a (n)”, a need section starting with “I want” and a goal section starting with “So that”, as shown in the below example:

### [User Story Example]

As an industrial manager who manages the process control system for a nuclear power plant.
I want to monitor all the sensors of the plant that measure metrics such as radiation levels, temperature, and water levels.
So that I can maintain the efficient running of the nuclear power plant without any foreseeable dangers.

Thus, the persona section starting with “As a (n)”, the need section starting with “I want to” and the goal section starting with “So that” together specify who wants what and why.

The goal of the further steps of the method of the present exemplary embodiment is to generate and output a REST API definition 4 that defines a REST path 3 and, optionally, a request body, of an API endpoint for functionality of the API-driven control application as per the requirements defined in the plain-text user story.

In step S2, the second unit 102 identifies a number of nouns and a number of verbs in the acquired plain-text user story 2.

The identification may be carried out based on a pre-defined vocabulary, i.e., by comparing each word comprised in the plain-text user story with a pre-defined list of verbs and a pre-defined list of nouns. Alternatively, natural language processing may be used to identify the nouns and the verbs.

One potential preferred development of how to use natural language processing to identify nouns and verbs is now described briefly.

That is, a Python code can be used that implements an NLP parts of speech tagging (POStagging) and identification algorithm based on the Natural Language Toolkit (NLTK) algorithm as published on https://github.com/nltk/nltk and described in Bird, Steven, Edward Loper and Ewan Klein (2009), Natural Language Processing with Python. O'Reilly Media Inc.

Specifically, the Python code imports the nltk library.

Then, the Python code splits up the plain-text user story into three strings: (i) a persona section string starting with “As a (n)”, a need section string with “I want” and a goal section string starting with “So that”.

Then, the Python code uses word_tokenize ( ) method to tokenize the persona section string, the need section string and the goal section string of the plain-text user story user story by passing the individual strings as method argument.

The result of the previous step is passed through the nltk.pos_tag ( ) method, which tags the respective words of the text.

The result of the previous step is further reduced by filtering out other parts of the speech except nouns and verbs. This can be done by nltk.RegexpParser, a method in nltk for regular expressions.

One example of a regular expression to remove adverbs, adjectives, prepositions, determiners or the word to is: “}<RB|JJ|IN|DT|TO>+{”.

One example of selecting only the nouns is:
nounList=list (filter (lambda x: x[1]=“NN”, persona_string)).

The above Python code implementation is just one example, and other natural language processing implementations can be used.

Returning to the description of the first exemplary embodiment, in the given example, the following verbs (shown underlined) and nouns (shown doubly underlined) are identified:

[User Story Example with Identified Verbs and Nouns]
As an industrial manager who manages the process control system for a nuclear power plant.
I want to monitor all the sensors of the plant that measure metrics such as radiation levels, temperature, and water levels
So that I can maintain the efficient running of the nuclear power plant without any foreseeable dangers.

It is noted that auxiliary verbs, such as “want”, “need”, “can” and “have”, may be excluded from being identified as verbs.

In step S3, the third unit 103 matches the identified number of verbs to one of a plurality of HTTP methods.

In the present example, a plurality of verbs are identified in the plain-text user story. Therefore, a most relevant verb is identified based on its position within the plain-text user story.

More specifically, in the present example, only verbs in the need section starting with “I want” are considered (although there is no limitation to this).

According to one variant, among the verbs in the need section, for example, the first verb in the need section, “monitor” in the present example, is identified as the most relevant verb.

Alternatively, natural language processing can be used to determine which verb constitutes the predicate of the sentence or sentence part in the need section. In the present example, “want to monitor” is the predicate of the main clause, while “measure” is only the predicate of a sub-ordinate clause. Hence, also in the present alternative, “monitor” is identified as the most relevant verb.

In a scenario in which only one single verb is identified, the identified verb is the most relevant and only verb.

After identifying the most relevant verb, the most relevant verb is matched against a library in which each HTTP method is associated with a number of verbs.

For example, the HTTP method “GET” may be associated with verbs such as “read”, “see”, “look”, “detect”, “fetch”, “monitor”, “check”. The HTTP method “POST” may be associated with verbs such as “create”, “set”, “write”, “add”, “change”. The HTTP method “DELETE” may be associated with verbs such as “remove” and “delete”.

It is noted that the precise contents of the library may be determined by automatically harvesting existing successful software development projects for which user stories and the associated API specifications are available.

That is, if the identified most relevant verb exactly matches one of the verbs in the library, the most relevant verb is matched to the HTTP method that is associated with the matching verb in the library.

If no exact match is found, natural language processing or a language-based artificial intelligence model may be used to obtain synonyms of the most relevant verb, and for each of the obtained synonyms, the above-described matching processing may be repeated until a match is found.

If neither the most relevant verb nor any of its synonyms could not be matched to a verb in the library, the method may select another one of the identified verbs as a new most relevant verb and repeat the processing described hereinabove.

If no match is achieved for any of the identified verbs, the method aborts with an error.

If a match was achieved, the matching HTTP method—GET in the present example—is selected for use in step S5, and the method proceeds with step S4.

In step S4, the fourth unit 104 matches the number of identified nouns to a number of HTTP resources.

It is noted that HTTP resources are not restricted in any particular way and can have arbitrary names. Thus, the matching of one or more identified nouns is performed by selecting one or more of the identified nouns as resources (resources names) that are used for forming the REST API path 3 and/or a request body description (not shown) comprised in the REST API definition 4.

More specifically, a most relevant noun of the identified nouns selected as a HTTP root resource, and a number of relevant nouns of the identified nouns may be identified as HTTP-sub resources.

The selection is performed based on criteria such as a position of the respective identified noun in the plain-text user story 2, a frequency of occurrences of the respective identified noun in the plain-text user story 2, a positional or grammatical relationship of the respective noun with the most relevant verb identified in step S3, and the like.

Merely as an example, in the present example, only nouns in the need section are considered to be HTTP resources, although there is no limitation to this.

Thus, in the present example, the nouns “sensors” and “plant”, “metrics”, “radiation levels”, “temperature” and “water levels” occur in the “need” section. From these, the word “plant” occurs a total of three times in the entire plain-text user story, while all other nouns only occur once. Therefore, the noun “plant” is identified as a relevant noun. Furthermore, also the noun “sensors” may be identified as a relevant noun, based on its occurrence in the need section before the noun “plant”.

From the relevant nouns, one noun is selected to be the HTTP root resource.

In one variant, the first of the relevant nouns in the need section, here “sensor”, can be selected as the HTTP root resource.

In another variant, natural language processing can be used to identify the noun that indicates an ultimate origin, or an ultimate destination of the action specified by the most relevant verb. In the present example, this would be the noun “plant” to which the sensors originate that are being “monitored”. Thus, “plant” could be selected to be the HTTP root resource.

Further nouns that are not selected as the HTTP root resource may be selected as HTTP sub resources. Preferably, a limit of the maximum number of HTTP sub resources is set, and if the number of HTTP sub resources exceeds the maximum number, the corresponding exceeding nouns may be selected to be used as sub-resources that become part of a request body description rather than part of the REST path 3.

In each case, the respective selection may be based on the same criteria that were cited hereinabove and/or on further criteria that the skilled person will be able to identify by running test cases with data from completed software development projects.

As was described above, one noun (for example “plant”) is matched to (selected as) the HTTP root resource, and one or more further nouns (for example, “sensor” and “metrics”) is matched to (selected as) a respective HTTP sub-resource.

However, any further nouns, such as “radiation levels”, “temperature” and “water levels” are selected as sub-resources (variable parameters) to be used in the request body of the HTTP GET method call.

In step S5, the fifth unit 105 builds a REST path 3 using the matched HTTP method and the number of matched HTTP resources.

The REST path 3 is built by concatenating the HTTP method, the HTTP root resource and the one or more HTTP sub-resources using separators and placing an identifier placeholder after each HTTP root resource and each HTTP sub-resources.

Thus, in the example, the following REST path 3 may be built:

### [REST Path Example]

$$GET \text{---} plant / \{ id \} / sensor \{ id \} / metrics \{ id \}$$

Herein, “GET” is the HTTP method, “plant” is the HTTP root resource, “sensor” and “metrics” are respective HTTP sub resources, “{id}” are the respective identifier placeholders, and “---” and “/” are separators.

The identifier placeholder is a placeholder that is used to pass a value, such as a numerical identifier, that identifies the specific instance of the respective HTTP resource (here, the specific plant, the specific sensor and the specific metrics to be fetched).

According to a preferred variant, more than one REST path is generated. For example, from what was described above, it follows that also the following REST path 3 may be built:

### [Further REST Path Example]

$$GET \text{---} sensor / \{ id \} / plant \{ id \} / metrics / \{ id \}$$

In a case where there is more than one HTTP sub-resource, the HTTP sub-resources may be ordered according to their order of occurrence in the plain-text HTTP. Additionally, all possible combinations of HTTP sub-resources in all possible orders may be explored by creating a plurality of REST paths 3, each comprising the plurality of HTTP sub-resources in a different order.

That is, the following further REST paths 3 may also be built:

### {Further REST Paths Examples}

$$GET \text{---} metrics \{ id \} / sensor / \{ id \} / plant / \{ id \}$$

$$GET \text{---} sensor \{ id \} / metrics / \{ id \} / plant / \{ id \}$$

$$GET \text{---} plant \{ id \} / metrics / \{ id \} / sensor / \{ id \}$$

$$GET \text{---} metrics \{ id \} / plant / \{ id \} / sensor \{ id \}$$

$$GET \text{---} plant / \{ id \} / sensor \{ id \}$$

$$GET \text{---} sensor / \{ id \} / plant \{ id \}$$

In step S6, the sixth unit 106 generates the REST API specification 4 according to an OpenAPI standard or the like. The REST API specification 4 comprises the one or more REST paths 3 that has or have been built in step S5. The REST API specification 4 may also comprise a request body description describing resources that can be used in a request body of the corresponding HTTP request, rather than in the REST path itself.

The generated REST API specification 4 is output, such as in the form of data in transmission or data at rest or as displayed data, and the method ends.

The REST API specification 4 generated in this way comprises one or more REST paths 3 from which a developer can choose one REST path 3 and proceed to code the functionality that implements the corresponding API endpoint of the API-driven control application.

Some further examples of user stories and corresponding generated REST paths are given below:

### [Second Example of a User Story]

As an industrial manager who uses the IoT platform.
I want to fetch all my assets from my plant which I need to supervise,
So that I have full information about the assets to check if my plant has any problems to resolve.

### [REST Paths Generated for Second Example of User Story]

$$GET \text{---} plant / \{ id \} / asset / \{ id \}$$

$$GET \text{---} asset / \{ id \} / plant \{ id \}$$

That is, the verb “fetch” being the predicate of the main clause of the “need” section is matched to the HTTP GET method, and either one of the direct object “assets” of the verb “fetch” or the noun “plant” as being the ultimate goal or ultimate source associated with the verb “fetch” is matched to (selected as) the HTTP root resource. Herein, it is noted that both “plant” and “assets” occur each two times in the plain-text user story.

### [Third Example of a User Story]

As an process engineer who controls the manufacturing execution system
I want to change the production process to attach a part with a different robot in a later step,
So that I can adapt the process easily and have a better integration of the supply chain

### [REST Paths Generated for Third Example of User Story]

$$POST \text{---} process / \{ id \} / part \{ id \} / robot \{ id \}$$

$$POST \text{---} process / \{ id \} / robot \{ id \} / part \{ id \}$$

That is, the verb “change” being the main predicate of the need section is matched to the HTTP POST method, and the noun “process” being the direct object of the verb “change” and occurring multiple times in the user story is identified matched with (selected as) the HTTP main resource.

The proposed computing device 1 and the proposed method automatically generate the REST API specification 4 from the plain-text user story 2, thereby ensuring that the developer, when coding the corresponding API endpoint of the API-driven control application, observes an API format that accepts input resources and provides output resources that correspond to the requirements set out in the plain-text user story 2.

Thus, API-driven software development is facilitated, early failure of a software development process due to API mismatches can be avoided, and a probability is increased that the developed API-driven control application will behave well according to the specified requirements. Thereby the operational stability of an industrial control system on which the API-driven control application will be deployed can be enhanced.

While the first exemplary embodiment described hereinabove is directed at facilitating API-driven development of API-driven control applications, experience shows that not all software developers are comfortable with API-driven development and prefer a code-driven approach in which the software developer creates code implementing the functionality requested by the plain-text user story based on human analysis of the plain-text user story and creates the API endpoints and their associated REST API definitions after coding is finished.

Therefore, a second exemplary embodiment is directed at ensuring operational stability of the industrial control system also in a scenario where an API-driven control applications has been developed using a code-driven approach, or where it is not known how an API-driven control application has been developed.

FIG. 3 is a diagram illustrating the functional configuration of a computing device 1′ according to the second exemplary embodiment, and FIG. 4 illustrates steps S11-S14 of a method according to the second exemplary embodiment.

The computing device 1′ comprises three sections 11, 12 and 13. The first section 11 comprises the first to sixth unit 101-106, which are similar to the first to sixth unit 101-106 of the computing device 1 of the first exemplary embodiment, and therefore will not be described again in detail.

The second section 12 of the computing device 1′ comprises a seventh unit 107 and an eight unit 108, and the third section 13 comprises a ninth unit 109, the functions of which are described hereinbelow.

In step S11 of the method of the second embodiment illustrated in FIG. 4, the seventh unit 107 receives, as input, source code 5 of an already developed API-driven control application.

The source code 5 may be written in any programming language suitable for developing APIbased services, such as ASP.NET, Python, PHP, Java, Javascript, Ruby, Go, and the like. The source code 5 may comprise a single file or a plurality of files, such as a plurality of source code files, a Makefile or other type of build instructions, and the like.

In step S12, the eighth unit 108 generates a REST API specification 7 comprising at least one REST path 6 based on the source code 5 received step S11.

Tools to generate OpenAPI REST API specifications 7 from source code 5 are available in the art. Such tools generate the OpenAPI REST API specification 7 by parsing and analysing the source code and the functionality (web-based services) provided thereby. If the source code is annotated, the annotations can also be used as additional basis for automatically generating the REST API specification 7.

Examples include Go Swagger for Go, SwashBuckle for ASP.NET, swagger-docs or openapirails for Ruby and Ruby on Rails, django-rest-swagger for Python, springdoc-openapi for Java, Swagger Maven Plugin for Java (JAX-RS), swagger php for PHP, and the like.

In step S13 of the second exemplary embodiment, the first to sixth units 101-106 perform the method of the first exemplary embodiment, i.e., steps S1 to S6 shown in FIG. 2. That is, the first unit 101 receives the plain-text user story 2, the second unit 102 identifies a number of nouns and a number of verbs in the plain-text user story 2, the third unit 103 matches the identified number of verbs to one of a plurality of HTTP methods, the fourth unit 104 matches the number of identified nouns to a number of HTTP resources, the fifth unit 105 builds one or more REST paths 3 using the matched HTTP method and the number of matched HTTP resources; and the sixth unit 106 generates and outputs a REST API specification 4 that comprises at least the one or more built REST paths 3.

In step S14, the ninth unit 109 of the third section 13 of the computing device 1′ of the second exemplary embodiment compares the REST API specification 4 generated by the first section 11 based on the plain-text user story 2 with the REST API specification 6 generated by the second section 12 based on the source code 5.

The comparison yields a match if, for example, if at least one of the one or more REST paths 3 comprised by the REST API specification 4 generated based on the plain-text user story 2 matches with at least one of the one or more REST paths 6 comprised by the REST API specification 7 generated based on the source code 5.

If a match is found, the ninth unit 109 successfully validates the API-driven control application (the source code 5 thereof) and outputs a validation OK result 8 in the form of a signal, of data in transfer or data at rest. Preferably, the validation OK result 8 may be attached to the source code using a cryptographic signature certifying the identity of an organizational owner of the computing device 1′ or the like. In this way a (non-shown) source code with a cryptographic signature certifying the validation result is advantageously obtained, so that trust in the (non-shown) signed and validated source code is increased.

If no match is found, validation fails and no validation OK result is output and/or a (non-shown) validation error result is output.

Thus, in a code-driven development approach, in which a human developer creates source code 5 based on human analysis of the plain-text user story 2, the computing device 1′ of the second exemplary embodiment can be used to validate the source code 5 and obtain the validation OK result 8 only if the source code 5 is likely to match the requirements set out in the plain-text user story 2 based on a comparison of the auto-generated REST API specifications 4, 7. Deployment of a API-driven control application built based on the source code 5 can be made dependent on the validation OK result 8. In this way, advantageously, operational stability of an industrial control system on which the API driven control application is deployed can be improved.

FIG. 5 is a diagram illustrating the functional configuration of a computing device 1″ according to a third exemplary embodiment.

The third exemplary embodiment is based on the second exemplary embodiment and only differences will be described.

That is, in the computing device 1″ of the third exemplary embodiment, the third section 13 furthe comprises a tenth unit 110. In step S14 (FIG. 4), the ninth unit 109 outputs the validation OK result 8 to the tenth unit 110. In a further step (not shown in the figures), the tenth unit 110 builds the API-driven control application 9 from the source code 3, under the condition that the validation OK result 8 is received.

Building the API-driven control application 9 may comprise such steps as compiling and linking the source code, packaging the source code 5, and/or any other steps required to convert the source code 5 into a form that is executable in a software execution environment (150 in FIG. 6) to which the API-driven control application 9 is to be deployed.

According to the third exemplary embodiment, the API-driven control application 9 is only built if it has been verified that the source code 5 matches the requirements set out in the plain-text user story 2 based on comparing the auto-generated REST API specifications 4 and 7.

FIG. 6 is a diagram illustrating the functional configuration of a system comprising an industrial control system 100 an industrial plant 200, a user computer 31 and a developer computer 32 according to a fourth exemplary embodiment.

The fourth exemplary embodiment illustrates how the computing device 1″, which is based on the computing device 1″ of the third exemplary embodiment, is used to increase the operational stability of the industrial control system 100 and the associated industrial plant 200.

The industrial plant 200 comprises a number of industrial devices 250, such as sensors, actors, conveyors, robots or the like, which are connected to the industrial control system 100 via a communication line 260, such as a bus or the like.

The industrial control system 100 comprises a software execution environment 150 in which a plurality of API-driven control applications 9 are executing. The plurality of API-driven control applications 9 interact with each other and with the industrial devices 250 to send signals to and/or receive signals from the plurality of industrial devices 250 and/or process data sent to and/or received from the plurality of industrial devices 250, so as to control operation of the industrial plant 200.

The industrial control system 100 further comprises a computing device 1″ which comprises the same configurations as the computing device 1″ of the third exemplary embodiment. Furthermore, the first unit 101 (FIG. 5) of the computing device 1′″ is configured to authenticate the user 21 before accepting a plaint-text user story 2 from the user 21 as input. Preferably, furthermore, the seventh unit 107 (FIG. 5) of the computing device 1″ is configured to authenticate either the user 21 or the developer 22 before accepting source code 5 from the user computer 31 or the developer computer 32 as input.

The user 21, who is an owner of the industrial plant 200 and/or is authorized or trusted by the owner of the industrial plant 200 to manage the industrial plant 200 may wish to have a further API-driven control application 9 installed in the software execution environment 150 of the industrial control system 100. The user 21 is a person who is knowledgeable and trusted in configuring the software of the industrial control system 100, however, the user 21 is not a software developer. Therefore, the user 21 tasks a software developer 22 with developing the desired API-driven control application 9. The software developer 22 is knowledgeable in writing code, but is not trained or trusted to properly configure the software of the industrial control system 100.

The user 21 uses his user computer 31 to write down requirements fort the API-driven control application 9 to be developed in the plain-text user story 2 and provides the plain-text user story 2 to the developer's 22 computer 32.

The developer 22 proceeds to develop source code 5 using his computer 32. The developer 22 may follow a code-driven development approach in which the user analyses the plain-text user story 2 himself and directly creates the source code 5 using his human expertise. In doing so, the developer 22 writes the source code 5 such as to provide API endpoints based on his human expertise.

Alternatively, the developer 22 may follow an API-driven development approach in which the user 21 or the developer 22 uses the computing device 1 of the first exemplary embodiment to automatically generate a REST API definition 4 (FIG. 1) definition describing API endpoints to be implemented. The developer 22 then develops the source code 5 so as to implement the API endpoints that are described by the REST API definition 4 (FIG. 1).

However, it may not be under control of the user 21 whether the developer 2 follows the API-driven development approach or the code-driven development approach.

The developer 22 then uses his computer 32 to provide the developed source code 5 to the computing device 1″ of the industrial control system 100. The developer 22 may authenticate directly with the computing device 1″ and provide the source code 5 directly to the computing device 1″. Alternatively, the developer 22 may return the source code 5 to the user 21, and the user 21 may authenticate with the computing device 1″ and may provide the source code to the computing device 1″.

The computing device 1″ then performs the functionality described for the third exemplary embodiment, i.e., it builds the API-driven control application 9 based on the received source code 5 only if the source code 5 is validated to match the requirements set out in the plain-text user story 2, based on a comparison of a REST API definition 4 (FIG. 4) auto-generated from the plain-text user story 2 and a REST API definition 7 (FIG. 4) auto-generated from the source code 5. Only if said validation is successful and the API-driven control application 9 is built, the computing device 1″ deploys the built API-driven control application 9 in the software execution environment 150 of the industrial control system 100.

The computing device 1″ may thus be described as a build support device 1″ that is part of a toolchain for developing and deploying API-driven control applications 9 in the software execution environment 150 of the industrial control system 100.

Therein, the industrial control system 100 and the industrial plant 200 connected thereto are advantageously safeguarded from deployment of misbehaving API-driven control applications that do not match the requirements that were set out by the trusted user 21 in the plain-text user story 2, and are safeguarded from any risks of logical and physical damage that could occur if such misbehaving API-driven control applications were deployed.

Although the present invention has been described in accordance with preferred exemplary embodiments, it is obvious for the person skilled in the art that modifications are possible in all exemplary embodiments.

The exemplary embodiments describe inputting a single plain-text user story 2 and generating a single REST API specification 4 based thereupon, as well as coding, building and deploying an API-driven control application 9 based on the single REST API specification 4.

However, the skilled person will appreciate that a single API-driven control application can provide a plurality of API endpoints. That is, when developing a single API-driven control application 9, the method of the first exemplary embodiment may also be performed multiple times for different plain-text user stories 2 to obtain a plurality of REST API specifications 4. In the method of the second to fourth exemplary embodiment, a plurality of plain-text user stories 2 may be input to the first unit 101 for a single piece of source code 5, and a plurality of REST API specifications 4 may be generated and output by the sixth unit 106. The second section 12 may generate a plurality of REST API specifications 7 for the single piece of source code 5. The ninth unit 109 may match the plurality of REST API specifications 4 with the plurality of REST

API specifications 7.

Moreover, it is also contemplated that a respective single REST API specification 4 could be generated based on a plurality of plain-text user stories 2. The REST paths 3 generated from each of the plurality of plain-text user story 2 could be integrated into a single REST API specification 4.

Both in the case of a single and in the case of multiple plain-text user stories 2, it is also contemplated that REST paths 3 having the same HTTP root resource could be grouped together using a tag or the like. A separate REST API specification 4 could be generated for each tag, or a single REST API specification 4 could be generated comprising REST paths 3 with a plurality of tags.

In particular, when combining a plurality of plain-text user stories 2 into a single REST API specification 4 and grouping the REST paths 3 by HTTP root resource can have the benefit that a situation can be discovered when different user stories 2 ask for the same type of API endpoint and/or when it is possible that a single API endpoint can be designed that serves the requirements of a plurality of plain-text user stories 2.

In the third exemplary embodiment, a specific arrangement was described in which the computing device 1″ is integrated into the industrial control system 100, directly deploys the generated API-driven control application 9 in the software execution environment 150 of the industrial control system 100, and the user 21 and the developer 21 authenticate with the first unit 101 and the seventh unit 107, respectively, when providing the user story 2 and the source code 5, respectively. However, this specific arrangement is not required, and other arrangements are also contemplated.

For example, the industrial control system 100 could be a distributed system such that the computing device 1″ that provides for source code validation and build support could be arranged at a different location than the software execution environment 150, and the computing device 1″ could communicated, directly or indirectly via other interposed devices, with the software execution environment 150, preferably using authentication and/or encryption, to cause deployment of the validated API-driven control application 9.

Likewise, also the respective sections 11-13 of the computing device 1″ do not need to be sections of a single computing device, but the computing device 1″ could also be a distributed computing devices with each of the sections 11-13 being implemented by a separate computing device and the sections 11-13 communicating, directly or indirectly via other interposed devices, with each other, preferably using authentication and/or encryption.

Thus, the gist of the third exemplary embodiment is implemented wherever, in a development toolchain that starts with a plain-text user-story 2 as an input, a source code 5 developed in response to the user-story 2 is validated by comparing a REST API specification 4 auto-generated based on the plain-text user story 2 with a REST API specification 7 auto-generated based on the source code 5, and technical measures are implemented that ensure that an API-driven control application 9 built from the source code 5 can only be implemented in a software execution environment 150 of an industrial control system 100 when said validation was successful.

### REFERENCE NUMERALS

1 computing device
2 plain-text user story
3 REST path
4 REST API definition
source code
6 REST path generated from source code
7 REST API definition generated from source code
8 validation result
9 API-driven control application
11 first section
12 second section
13 third section
101-110 first to tenth unit
21 user
22 developer
31 user PC
32 developer PC
100 industrial control system
150 software execution environment
200 industrial plant
250 industrial devices
260 communication line

1. A computer-implemented method for automatically generating a representational state transfer, REST, application programming interface, API, specification based on a plain-text user story, the method comprising:
a) receiving, as input, the plain-text user story comprising a number of plain-text sentences that constitute a requirements definition for an API-driven control application to be developed;
b) identifying a number of nouns and a number of verbs in the acquired plain-text user story;
c) matching the identified number of verbs to one of a plurality of HTTP methods;
d) matching the number of identified nouns to a number of HTTP resources;
e) building a REST path using the matched HTTP method and the number of matched HTTP resources; and
f) generating and outputting a REST API specification that comprises at least the built REST path.

2. The method of claim 1,
wherein in step b), the number of nouns and the number of verbs are identified by comparing each word comprised by each of the number of plain-text sentences with a predetermined list of verbs and a predetermined list of nouns.

3. The method of claim 1,
wherein in step b), the number of nouns and the number of verbs are identified through natural language processing.

4. The method of claim 1,
wherein if in step b), a plurality of verbs are identified, a most relevant verb of the plurality of verbs is identified based on its position within the plain-text user story, and the most relevant verb is matched to one of the plurality of HTTP methods in step c).

5. The method of claim 4,
wherein in step c), the most relevant verb is matched to a library in which each HTTP method is associated with a number of verbs.

6. The method of claim 1,
wherein, if in step b), a plurality of nouns are identified, in step d), one of the plurality nouns is identified as a HTTP root resource to be used in the REST path, and a number of the plurality of nouns are identified as sub-resources, based on criteria including one or more of:
a position of the respective noun in the plain-text user story;
a frequency of occurrence of the respective noun in the plain-text user story;
a positional or grammatical relationship of the respective noun with the one of the number of plurality of verbs that was matched to the HTTP method.

7. The method of claim 6,
wherein, if the number of nouns identified as sub-resources is greater than a predetermined threshold, the number of nouns identified as sub-resources is further subdivided, based on the criteria, into a first number of nouns to be used as HTTP sub-resources in the REST path and a second number of nouns to be used as sub-resources in a request body description, and the REST API specification generated in step f) further comprises the request body description.

8. The method of claim 6,
wherein, if in step b), a plurality of nouns are identified as HTTP sub-resources to be used in the REST path, in step e), a plurality of REST paths is generated, each of the plurality of REST paths comprising the HTTP root resource and, in an order that differs for each of the plurality of REST paths, the HTTP sub-resources, and in step f), the plurality of REST paths is included in the REST API specification.

9. The method of claim 1, further comprising steps for validating the API-driven control application prior to its deployment to an industrial control system, the further steps comprising:
g) receiving, as input, source code of the API-driven control application,
h) generating a REST API specification based on the received source code of the API-driven control application,
i) validating the API-driven control application under the condition that the REST API specification generated in step h) based on the source code of the API-driven control application matches the REST API specification generated in step f) based on the plain-text user story.

10. The method of claim 9, further comprising:
j) building the API-driven control application from the received source code only if the validation step i) is successful.

11. The method of claim 9, further comprising:
k) deploying the API-driven control application to the industrial control system only if the validation step i) is successful.

12. A computer program product comprising a program code for executing the method of claim 1 when run on at least one computer.

13. A computing device configured for automatically generating a representational state transfer, REST, application programming interface, API, specification based on a plain-text user story, the computing-device comprising:
a) a first unit configured to receive, as input, the plain-text user story comprising a number of plain-text sentences that constitute a requirements definition for an API-driven control application to be developed;
b) a second unit configured to identify a number of nouns and a number of verbs in the acquired plain-text user story;
c) a third unit configured to match the identified number of verbs to one of a plurality of HTTP methods;
d) a fourth unit configured to match the number of identified nouns to a number of HTTP resources;
e) a fifth unit configured to build a REST path using the matched HTTP method and the number of matched HTTP resources; and
f) a sixth unit configured to generate and output a REST API specification that comprises at least the built REST path.

14. The computing device of claim 13, further configured for validating the API-driven control application prior to its deployment to an industrial control system, the computing device further comprising:
g) a seventh unit configured to receive, as input, source code of the API-driven control application,
h) an eight unit configured to generate a REST API specification based on the received source code of the API-driven control application,
i) a ninth unit configured to validate the API-driven control application under the condition that the REST API specification generated by the eight unit based on the source code of the API-driven control application matches the REST API specification generated by the sixth unit based on the plain-text user story.

15. An industrial control system comprising a software execution environment to which one or more API-driven control applications for controlling one or more industrial devices are deployable and further comprising the computing device of claim 13.
